(19) United States
(12) Patent Application Publication
(10) Pub. No.: US 2005/0286873 A1
(43) Pub. Date: Dec. 29, 2005

(54) Video and audio recorder and method of operating the same

(76) Inventors: Kouji Kamogawa, Yokohama (JP); Masayuki Inoue, Yokohama (JP); Yoko Morimoto, Yokohama (JP); Hiroshi Sasamoto, Yokohama (JP); Yoshihiro Machida, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/165,214

(22) Filed: Jun. 24, 2005

(30) Foreign Application Priority Data
Jun. 28, 2004 (JP) 2004-189058

(51) Int. Cl. H04N 7/26

(52) U.S. Cl. 386/111; 386/112

(57) ABSTRACT

A video and audio recorder and a method of operating the same. The recorder includes a TV signal receiving unit, a video/audio compression recording control unit for compressing the video and audio signals and outputting a compressed video/audio multiplex data at the time of recording a program, an accumulation recording unit for recording the compressed video/audio multiplex data in a recording medium, and a recording control unit for controlling the video/audio compression recording control unit thereby to control the program recording operation. The recording control unit, based on the program information of the program to be recorded, controls the program recording operation by setting proportion information between the video recording bit rate and the audio recording bit rate in the compression process of the video and audio signals in the video/audio compression recording control unit.

### INCORPORATION BY REFERENCE

The present application claims priority from Japanese application JP2004-189058 filed on Jun. 28, 2004, the content of which is hereby incorporated by reference into this application.

### BACKGROUND OF THE INVENTION

This invention relates to a video and audio recorder for recording a program broadcast or distributed from a broadcast station, or in particular to a technique effectively applicable to the recording at the time of viewing the program or the setting of the recording mode for recording reservation.

In the conventional recorder for recording the program broadcast or distributed from a broadcast station, the recording mode such as high quality (HQ), standard (SP) or long play (LP) for the recording while viewing the program or the program recording reservation can be selected by the user adjusting the video or audio recording bit rate.

Also, according to the prior art, a program recorder is available (JP-A-2001-36861, for example) in which the recording mode is set automatically by being determined based on an electronic program table (hereinafter referred to as EPG) data.

### SUMMARY OF THE INVENTION

In the prior art, the recording mode can be selected by the user at the time of recording as described above. In the case where the video and audio recording bit rate are adjusted in accordance with the contents of the program to be recorded, however, the user is required to determine and set the optimum recording bit rate at the time of recording.

Specifically, in the case where it is desired to record a program of a specified category such as a music or a movie with a higher sound quality, or a program of a specified category such as a sport accompanied by violent action with a higher image quality, the user is required to consciously select, not the recording mode, but the video or audio recording bit rate and the video or audio recording format for the program to be recorded.

In the program recorder described in JP-A-2001-36861, only the recording mode for determining the overall compression ratio is determined based on the EPG data, and the video and audio recording bit rates are fixed by the recording mode. In the same recording mode, therefore, the proportion between the video and audio recording bit rates cannot be changed based on the EPG data.

Accordingly, it is an object of this invention to provide a video and audio recorder in which the proportion between the video recording bit rate and the audio recording bit and the video and audio recording format for the recording operation can be controlled in accordance with the contents of the program to be recorded.

The representative aspects of the invention disclosed herein are briefly described below.

According to this invention, there is provided a video and audio recorder comprising a TV signal receiving unit for receiving a broadcast program and outputting video and audio signals, a video/audio compression recording control unit for compressing the video and audio signals output from the TV signal receiving unit and outputting a compressed video/audio multiplex data at the time of recording the program, an accumulation recording unit for recording the compressed video/audio multiplex data output from the video/audio compression recording control unit in a recording medium, and a recording control unit for controlling the recording of the program by controlling the video/audio compression recording control unit, wherein the recording control unit controls the program recording by setting the proportion between the video recording bit rate and the audio recording bit rate for the compression of the video and audio signals in the video/audio compression recording control unit based on the information on the program to be recorded.

The typical effects of the invention disclosed herein are briefly described below.

According to this invention, while keeping the same total recording bit rates, the video and audio recording bit rates can be controlled and also the video and audio recording formats can be automatically selected in accordance with the characteristics of the program to be recorded.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a configuration of a video and audio recorder according to an embodiment of the invention.

FIG. 2 is a diagram showing a configuration of the video/audio compression recording control unit of the video and audio recorder according to the embodiment of the invention.

FIG. 3 is a diagram showing a configuration of the video/audio compression recording control unit of the video and audio recorder according to the embodiment of the invention.

FIG. 4 is a diagram showing an example of a recording bit rate control reference table for the video and audio recorder according to the embodiment of the invention.

FIG. 5 is a diagram showing an example of a recording scheme control reference table of the video and audio recorder according to the embodiment of the invention.

FIG. 6 is a flowchart showing the manual recording operation by the user of a video and audio recorder according to an embodiment of the invention.

FIG. 7 is a flowchart showing the operation of the recording reservation by the user of the video and audio recorder according to the embodiment of the invention.

FIG. 8 is a flowchart showing the operation of executing the recording as reserved in the video and audio recorder according to the embodiment of the invention.

FIGS. 9A to 9D are diagrams for explaining the recording bit rates for recording a wide-screen broadcast program in a video and audio recorder according to an embodiment of the invention.

### DESCRIPTION OF THE EMBODIMENTS

An embodiment of the invention is explained in detail below with reference to the drawings. In all the drawings for explaining the embodiments, the same component elements are designated by the same reference numerals, respectively, and not described repeatedly.

<Recorder Configuration>

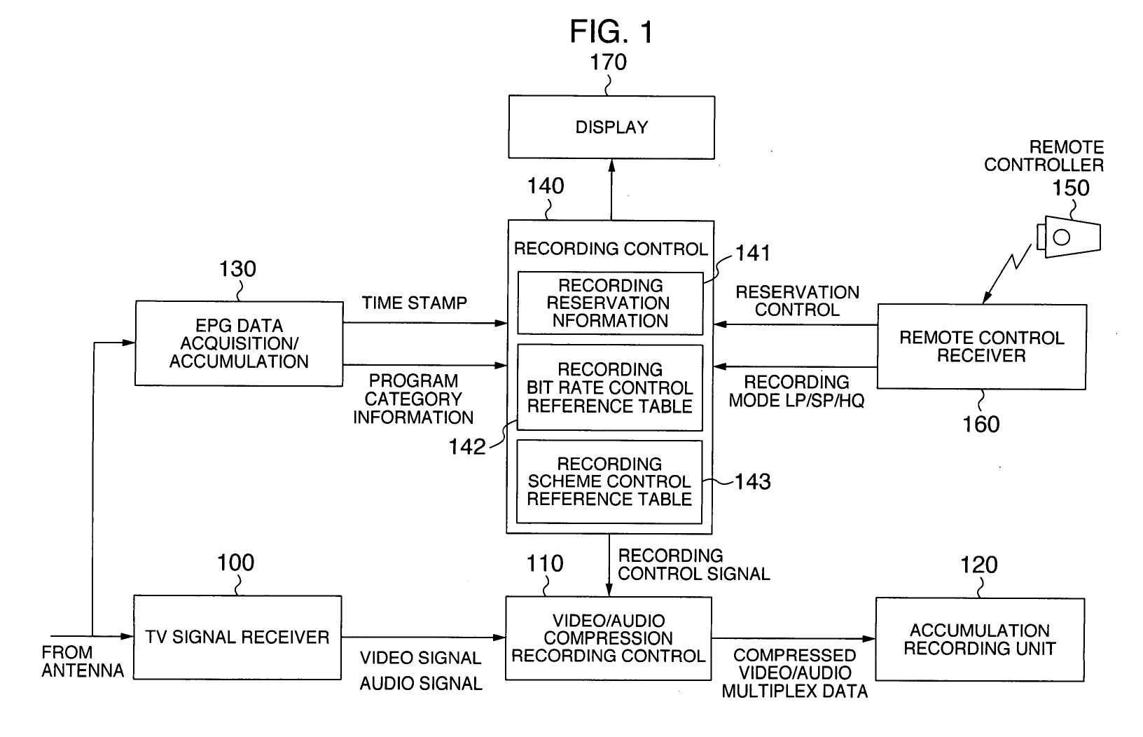

With reference to FIG. 1, an example of a configuration of the recorder according to an embodiment of the invention is explained. FIG. 1 is a diagram showing a configuration of the recorder according to the embodiment.

In FIG. 1, the recorder comprises a TV signal receiving unit 100, a video/audio compression recording control unit 110, an accumulation recording unit 120, an EPG acquisition/accumulation unit (electronic program table data acquisition/accumulation unit) 130, a recording control unit 140, a remote controller 150, a remote control receiving unit 160 and a display 170.

The TV signal receiving unit 100 receives a program broadcast or distributed from a broadcast station, etc. and outputs a video signal and an audio signal of the program. In the case where the program is for analog broadcast, an analog video signal and an analog audio signal are output. In the case where the program is for digital broadcast, on the other hand, a digital signal having the video and audio signals multiplexed with each other is output.

The video/audio compression recording control unit 110 is supplied with the video signal and the audio signal from the TV signal receiving unit 100. The video/audio compression recording control unit 110 controls the compression of the video and audio signals, and the video and audio signals thus compressed are multiplexed and output as a compressed video/audio multiplex data.

The accumulation recording unit 120 is supplied with the compressed video/audio multiplex data from the video/audio compression recording control unit 110, and the compressed video/audio multiplex data are recorded for the program in a recording medium such as a hard disk or a DVD.

The EPG data acquisition/accumulation unit 130 acquires and accumulates the EPG data transmitted together with the program broadcast or distributed from the broadcast station, etc. The EPG data holds the program information such as the time stamps and the category information for the program, which are used to reserve the program recording or determine the recording bit rate or the recording scheme. Also, the EPG data is multiplexed on the broadcast wave. Specifically, the EPG data is multiplexed on VBI (vertical blanking interval) for analog broadcast, and multiplexed as another stream than the video and audio signals in the case of digital broadcast. The EPG data acquisition/accumulation unit 130 may acquire the EPG data either from the TV signal receiving unit 100 or the internet or the like instead of from a broadcast station.

The recording control unit 140 controls the recording bit rate at the time of the recording reservation or the recording in accordance with the EPG data from the EPG data acquisition/accumulation unit 130, or the reservation control and the setting of the recording mode received by the remote control receiving unit 160 from the user operating the remote controller 150. The recording control unit 140 has preliminarily stored therein the recording reservation information 141, a recording bit rate control reference table 142 for controlling the recording bit rate in recording mode and a recording scheme control reference table 143 for controlling the recording scheme.

The display 170 displays the operation screen at the time of the reserve operation by the recording control unit 140. The display 170 also displays the program from the broadcast station and the program recorded in the accumulation recording unit 120.

<Configuration of Video/Audio Compression Recording Control Unit>

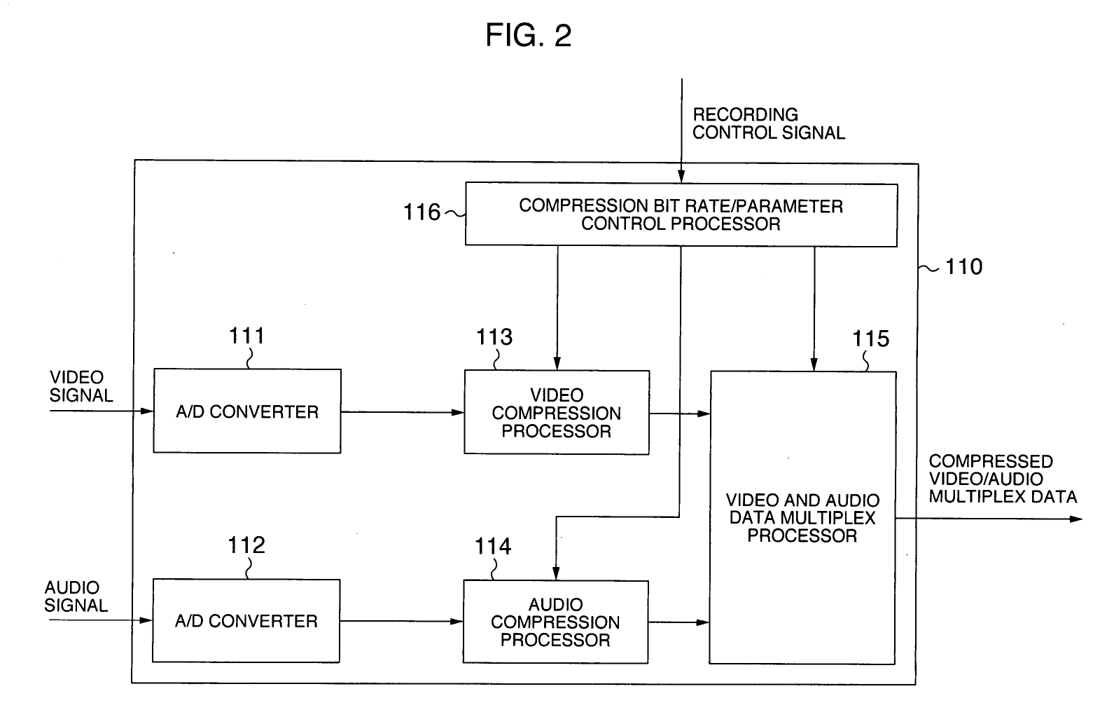

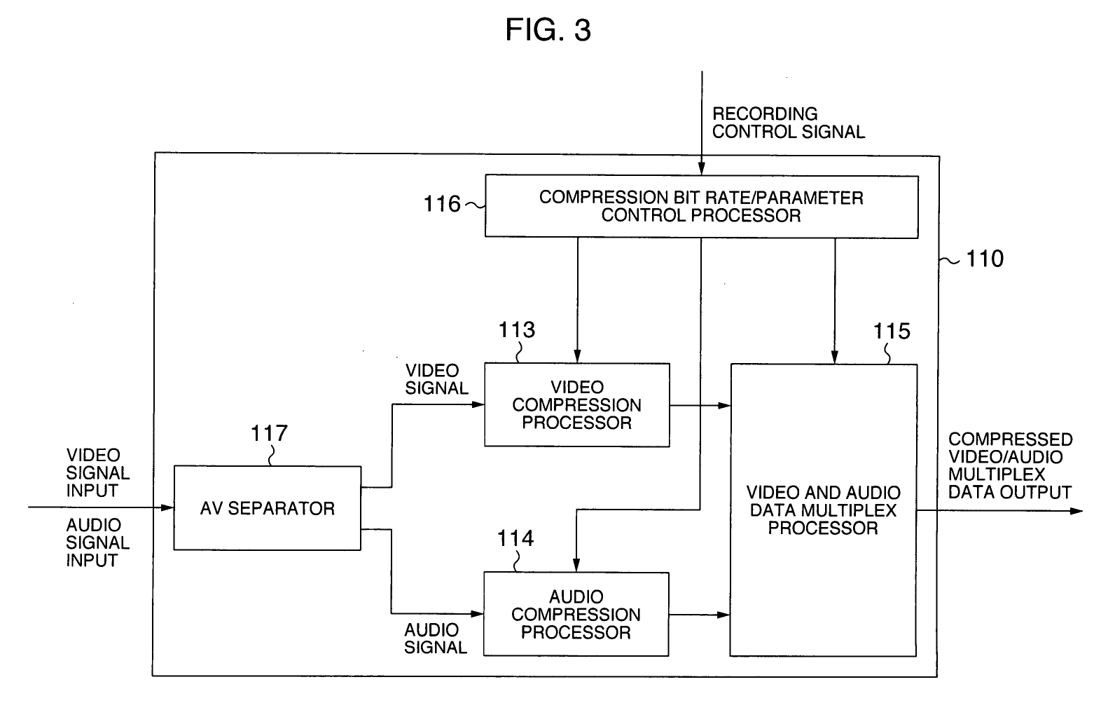

Next, with reference to FIGS. 2 and 3, an example of a configuration of the video/audio compression recording control unit of the recorder according to the embodiment of the invention is explained. FIGS. 2 and 3 are diagrams showing a configuration of the video/audio compression recording control unit of the video and audio recorder according to the embodiment of the invention. FIG. 2 shows a configuration in which analog video and audio signals are output from the TV signal receiving unit 100, and FIG. 3 a configuration in which a digital signal with the video and audio signals multiplexed on each other is output from the TV signal receiving unit 100.

In FIG. 2, the video/audio compression recording control unit 110 is configured of analog-to-digital (A/D) converters 111, 112, a video compression processor 113, an audio compression processor 114, a video/audio data multiplexing processor 115 and a compression bit rate/parameter control processor 116.

The A/D converters 111, 112 output by converting the analog video and audio signals from the TV signal receiving unit 100 into digital video and audio signals, respectively.

The video compression processor 113 executes the process of compressing the digital video signal.

The audio compression processor 114 executes the process of compressing the digital audio signal.

The video/audio data multiplex processor 115 multiplexes the video and audio signals compressed by the video compression processor 113 and the audio compression processor 114, respectively, and outputs a compressed video/audio multiplex data.

The compression bit rate/parameter control processor 116, based on the recording control signal from the recording control unit 140, controls the video compression processor 113, the audio compression processor 114 and the video/audio data multiplex processor 115 on the one hand and controls the compression bit rate, the compression parameter and the video scheme on the other hand.

In FIG. 3, the video/audio compression recording control unit 110 is configured of an AV separator 117, the video compression processor 113, the audio compression processor 114, the video/audio data multiplex processor 115 and the compression bit rate/parameter control processor 116.

The AV separator 117 separates the digital signal output from the TV signal receiving unit 100, which contains the video and audio signals multiplexed with each other, into a digital video signal and a digital audio signal and outputs the separated digital signals.

<Example of the Recording Bit Rate Control Reference Table and the Recording Scheme Control Reference Table>

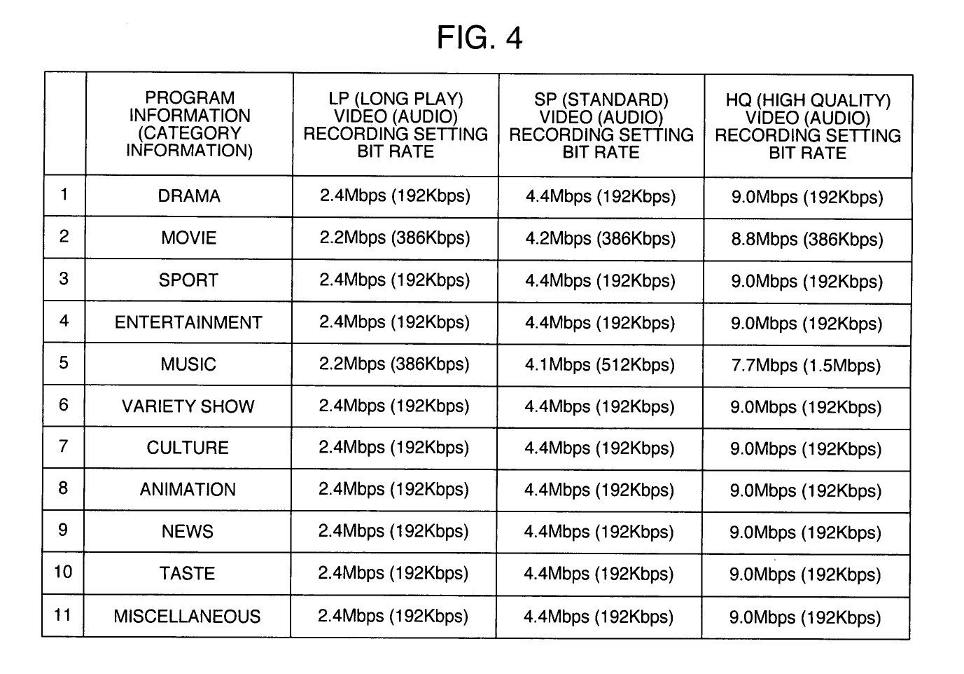

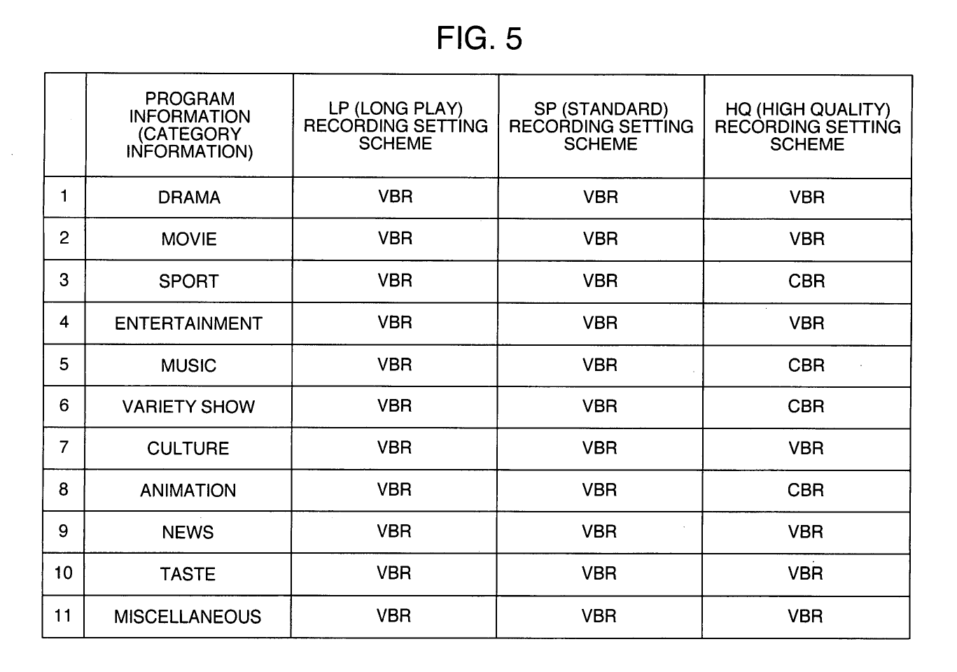

Next, with reference to FIGS. 4 and 5, an explanation is given about an example of the recording bit rate control reference table 142 and the recording scheme control reference table 143 of the video and audio recorder according to the embodiment of the invention. FIG. 4 is a diagram showing an example of the recording bit rate control reference table of the recorder according to the embodiment of the invention, and FIG. 5 a diagram showing an example of the recording scheme control reference table of the recorder according to the embodiment of the invention.

According to this embodiment, the proportion between the video and audio recording bit rates and the video and audio recording formats can be set based on the program category information from the EPG data in the same recording mode (for example, HQ (high quality), SP (standard) or LP (long play)).

In the case where the audio and video recording bit rate is fixed at 4.6 Mbps in SP mode, for example, the bit rate allocation to video and audio signals may be determined in different proportions between video recording bit rate and audio recording bit rate as follows according to the program category:
(a) Drama, news and variety show (video 4.4 Mbps and audio 192 Kbps)
(b) Movie (video 4.2 Mbps and audio 386 Kbps)
(c) Music (video 4.1 Mbps and audio 512 Kbps)

Alternatively, proportion of video recording bit rate to audio recording bit rate may be determined in accordance with the program category as follows, and thereby the video recording bit rate and the audio recording bit rate are distributed based on the total recording bit rate.
(a) Drama, news and variety show (video/audio=20/2)
(b) Movie (video/audio=20/3)
(c) Music (video/audio=20/4)

In the case where the audio coding scheme and the audio bit rate (the remainder is the video bit rate) are fixed, on the other hand, the audio coding scheme and the audio bit rate are determined as described below, and the remainder is determined as the video bit rate. In this way, the bit rate distribution between audio and video signals is determined.
(a) Drama, news and variety show (MPEG1 and coding rate of 192 Kbps)
(b) Movie (DolbyAC3 and coding rate of 384 Kbps)
(c) Music (LPCM and coding rate of 1.5 Mbps)

Based on this bit rate distribution between audio and video signals, the recording bit rate control reference table 142 as shown in FIG. 4 is prepared and stored in the recording control unit 140. By accessing the recording bit rate control reference table 142 at the time of recording a program, the bit rate distribution between audio and video signals can be determined based on the program category.

In the case shown in FIG. 4, the audio signal is fixed to DolbyAC3 and 384 Kbps in coding rate for the movie, and based on the whole bit rate of audio and video signals set in accordance with the recording mode, etc., the remainder of the audio bit rate allocated to the audio signal is determined as the video bit rate.

With regard to a music program, on the other hand, in the case where the audio and video recording bit rate is set to 8 Mbps or more in accordance with the recording mode (HQ mode, for example), the audio signal is fixed at LPCM and 1.5 Mbps in coding rate. In the case where the audio and video recording bit rate is set at 4 Mbps to 8 Mbps (SP mode, for example), the audio signal is fixed at DolbyAC3 and 512 Kbps in coding rate. Also, in the case where the audio and video recording bit rate is set 4 Mbps or less (LP mode, for example), the audio signal is fixed at DolbyAC3 and 384 Kbps in coding rate and based on the bit rate of the audio and video signals as a whole set according to the recording mode, etc., the remainder of the audio bit rate allocated to the audio signal is distributed to the video bit rate.

With regard to other than movies and music, the audio signal is fixed to MPEG1 and 192 Kbps in coding rate, and based on the bit rate of audio and video signals as a whole set according to the recording mode, etc., the remainder of the audio bit rate allocated to the audio signal is distributed to the video bit rate.

Also, as shown in FIG. 5, the recording scheme control reference table 143 for controlling the recording scheme including the variable bit rate (VBR) and the fixed bit rate (CBR) is stored in the recording control unit 140. This is by reason of the fact that although the deterioration of an image portion involving a violent action can be normally reduced by selecting the recording scheme of variable bit rate (VBR) in a low bit rate range, selection of the variable bit rate (VBR) for recording a program involving a violent action with high image quality (HQ mode) in a high bit rate would deteriorate the image quality due to the process of changing the bit rate, and therefore the recording scheme of the fixed bit rate (CBR) is selected in accordance with the program category.

In the case shown in FIG. 5, for example, the fixed bit rate (CBR) is employed for the program category including “sports”, “music”, “variety show” and “animation” in high image quality (HQ) mode, and the variable bit rate (VBR) for the other categories.

The table shown in FIGS. 4 and 5 are only an example, and for the same program category such as “music”, for example, a table can be prepared by determining the bit rate proportion between audio and video signals according to the type of the music program such as pops or classics or as a user mode for the program category set by the user.

The tables shown in FIGS. 4 and 5 are not necessarily employed, but any table configuration can be employed which can determine the bit rate proportion between audio and video signals based on the program category information of the EPG data.

<Operation for Recording and Recording Reservation>

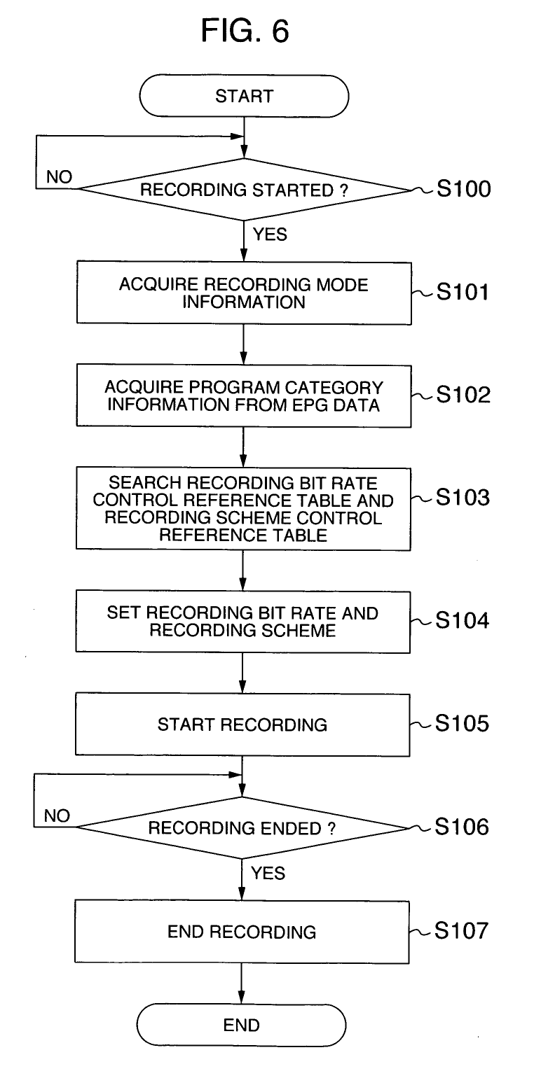

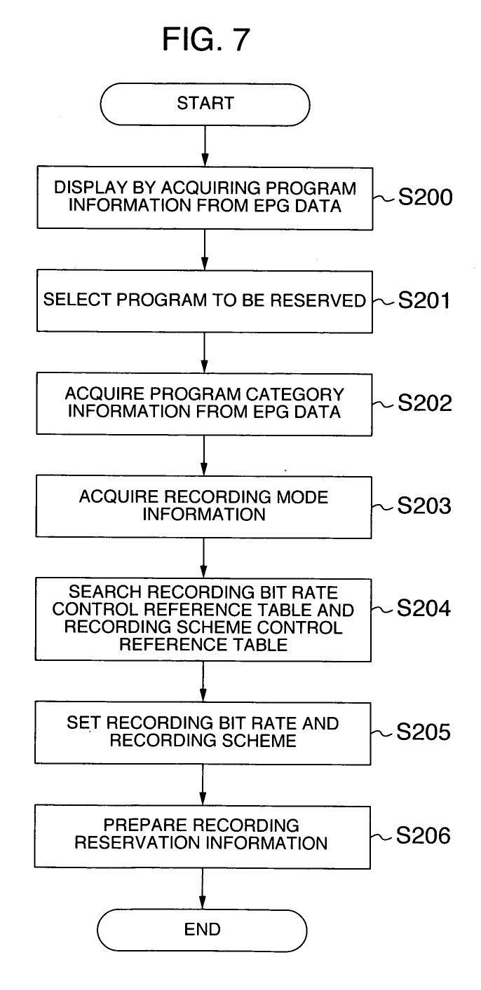

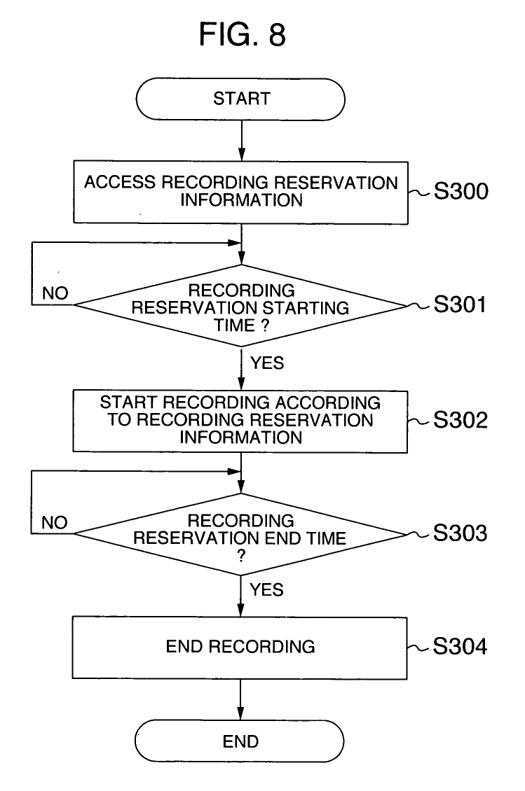

With reference to FIGS. 6 to 8, the recording operation and the operation of recording reservation in the recorder according to the embodiment of the invention are explained. FIG. 6 is a flowchart showing the manual recording operation of the recorder by the user according to the embodiment of the invention, FIG. 7 a flowchart showing the user operation of the recorder for recording reservation according to the embodiment of the invention, and FIG. 8 a flowchart showing the operation for executing the recording reservation in the recorder according to the embodiment of the invention.

First, the manual program recording operation by the user while viewing the program is performed as shown in FIG. 6. Specifically, by the recording operation or the like of the user, it is determined whether the recording is started or not (S100), and upon determination at step S100 that the recording is not started, the process returns to step S100. Upon determination at step S100 that the recording is started, on the other hand, the recording mode information is acquired from the contents of the user recording operation (S101).

The category information of the program to be recorded is acquired from the EPG data accumulated in the EPG data acquisition/accumulation unit 130 (S102), and based on the recording mode acquired at step S101 and the program category information acquired at step S102, the recording bit rate control reference table 142 and the recording scheme control reference table 143 are searched (S103).

The recording bit rate and the recording scheme retrieved at step S103 are set (S105) and the recording is started (S105).

It is determined by user operation, etc. whether the recording is ended or not (S106), and upon determination at step S106 that the recording is not yet ended, the process returns to step S106, where upon determination that the recording is ended, the recording operation is ended (S107).

In the case where the program recording started at step S105 is ended and the next program is started, the program end is recognized by the EPG data accumulated in the EPG data acquisition/accumulation unit 130, and the steps S102 to S104 may be executed again for the next program, so that the next program is recorded according to the recording scheme and the recording bit rate based on the program category information.

The operation of program recording reservation by the user operation of recording reservation is performed as as shown in FIG. 7 in such a manner that the program information is acquired from the EPG data accumulated in the EPG data acquisition/accumulation unit 130 and displayed on the display 170 (S200).

Once the program reserved for recording is selected by the user (S201), the category information of the program to be recorded is acquired from the EPG data accumulated in the EPG data acquisition/accumulation unit 130 (S202), and the recording mode information is acquired from the contents of the user operation for recording reservation (S203).

Based on the program category information acquired at step S202 and the recording mode acquired at step S203, the recording bit rate control reference table 142 and the recording scheme control reference table 143 are searched (S204).

The recording bit rate and the recording scheme retrieved at step S204 are set (S205), and the recording reservation information 141 is prepared (S206).

At step S201, a plurality of programs can be reserved by designating the recording time instead of selecting a program to be reserved. The 4-hour recording operation from a given time point, for example, can be reserved.

In this case, the recording bit rate and the recording scheme are set in such a manner that the proportion of the recording time between a plurality of the programs included in the four-hour period is determined, and the recording bit rate and the recording scheme are determined with the program having the longest recording time as a typical case. Assume, for example, that the program categories for the four-hour recording time include a variety show of one hour, a movie of two hours and a news of one hour. The proportion of the recording time is highest for the movie, and therefore the recording bit rate and the recording scheme corresponding to the move is set as a typical case.

In the case where the recording is reserved in terms of recording time and a plurality of programs are contained in the recording time, the programs included in the recording time are confirmed from the EPG data accumulated in the EPG data acquisition/accumulation unit 130. Then, the recording bit rate and the recording scheme can be set individually for each of the programs.

With regard to the recording operation after preparing the recording reservation information 141 by the user, as shown in FIG. 8, the recording reservation information 141 is accessed (S300) thereby to determine whether the recording reservation starting time has arrived or not (S301).

Upon determination at step S301 that the recording reservation starting time has yet to arrive, the process returns to step S301, at which upon determination that the recording reservation starting time has arrived, the recording is started according to the recording reservation information 141 (S302).

Then, it is determined whether the recording reservation end time has arrived or not (S303), and upon determination at step S303 that the recording reservation end time has not arrived, the process returns to step S303, at which upon determination that the recording reservation end time has arrived, the recording is ended (S304).

<Recording Bit Rate for Recording Wide-Screen Broadcast Program>

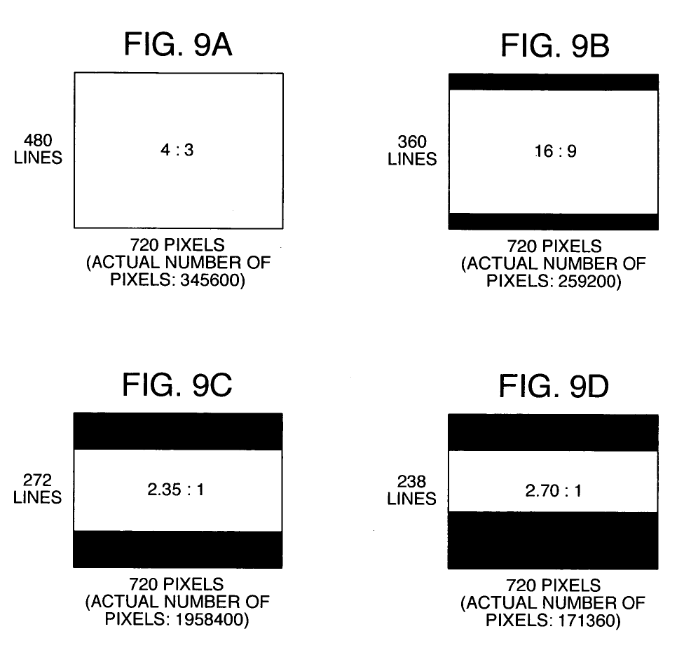

Next, an example of the recording bit rate for recording a wide-screen broadcast program in a recorder according to the embodiment of the invention is explained with reference to FIGS. 9A to 9D. FIGS. 9A to 9D are diagrams for explaining the recording bit rate for recording a wide-screen broadcast program in the recorder according to the embodiment of the invention, in which FIG. 9A shows a screen having the aspect ratio of 4 to 3, FIG. 9B a screen having the aspect ratio of 16 to 9, FIG. 9C a screen having the aspect ratio of 2.35 to 1, and FIG. 9D a screen having the aspect ratio of 2.70 to 1.

The NTSC system and the PAL system employ a TV cathode ray tube having the aspect ratio of 4 to 3. The movie is screened in a theater, on the other hand, on a horizontally long wide screen having the aspect ratio of 16 to 9, 2.35 to 1 or 2.70 to 1. In broadcasting a wide-screen program on a TV system having the aspect ratio of 4 to 3, therefore, black bands normally appear in the upper and lower parts of the screen as shown in FIGS. 9B to 9D.

The EPG data contains the screen size information and the program information indicating a wide screen as well as the program category information indicating a movie. Apart from the EPG data, the aspect information inserted in the vertical blanking interval of the input analog video signal may be used.

In the normal NTSC digital recorder, for example, the pixels are generally configured with the sampling rate of 720 pixels by 480 lines as shown in FIG. 9A.

In the wide-screen broadcast, however, the constant appearance of the black bands in the upper and lower parts of the screen totally eliminates the motion in the recording scheme such as MPEG, and no data is assigned to the portion having only the DC frequency component. As shown in FIGS. 9B to 9D, therefore, signals are processed in an amount corresponding to 720 pixels by 360 lines, 720 pixels by 272 lines or 720 pixels by 238 lines. Thus, the amount of data assigned to each pixel is 1.3 to 2 times larger than in the format of 720 pixels by 480 lines.

In the case of a wide-screen program, therefore, the data amount per pixel remains substantially the same even after selecting the recording bit rate about 1/1.3 to 1/2 times that of the program having the aspect ratio of 4 to 3.

In the recording bit rate control reference table 142 shown in FIG. 4, therefore, the recording bit rate of the image such as a wide-screen movie is determined at about 1/1.3 to 1/2 times as large as the recording bit rate of an image of a program having the aspect ratio of 4 to 3. Then, the data amount can be reduced while maintaining substantially the same image quality as the program having the aspect ratio of 4 to 3, thereby making possible a correspondingly longer recording operation.

As an alternative, the recording bit rate for the movie in the recording bit rate control reference table 142 shown in FIG. 4 is used as it is, while in the case of a wide-screen movie, the recording bit rate of the image is set to 1/1.3 to 1/2 times as large according to the related information.

According to this embodiment, the recording mode such as HQ (high quality), SP (standard play) or LP (long play) is selected by the user. Nevertheless, the recording mode may be set based on the program category information. In such a case, as long as the recording mode is not designated by the user, the recording mode and the video and audio recording bit rates for the particular recording mode are set based on the category information of the program to be recorded.

As described above, according to this embodiment, the recording bit rate control reference table 142 and the recording scheme control reference table 143 are searched and the video/audio recording bit rate and the video/audio recording format are controlled based on the program category information of the EPG data. Even in the case where the total recording bit is the same, therefore, the video/audio recording bit rate can be controlled and the video/audio recording format automatically selected in accordance with the program characteristics.

The invention achieved by the present inventor is specifically described above with reference to embodiments. This invention, however, is not limited to these embodiments, but of course variously modifiable without departing from the spirit and scope thereof.

It should be further understood by those skilled in the art that although the foregoing description has been made on embodiments of the invention, the invention is not limited thereto and various changes and modifications may be made without departing from the spirit of the invention and the scope of the appended claims.

1. A video and audio recorder for receiving a TV broadcast program and recording the contents of the program, comprising:
a TV signal receiving unit for receiving the broadcast program and outputting the video information and the audio information of the program;
a compression recording control unit for compressing the video information and the audio information;
an accumulation recording unit for multiplexing and recording the compressed video information and the compressed audio information in a recording medium:
program information acquisition means for acquiring the program information of the TV broadcast program; and
a recording control unit for determining the compression conditions of the compression recording control unit based on the program information;

2. A video and audio recorder according to claim 1, further comprising:
a recording bit rate control table for recording the recording bit rate of the video information and the audio information, respectively, at the time of compression thereof;
wherein the recording control unit determines the compression conditions of the compression recording control unit with reference to the recording bit rate control table based on the program information of the program.

3. A video and audio recorder according to claim 1, further comprising:
a recording bit rate control table for recording the recording bit rate of the video information and the audio information, respectively, at the time of compression thereof, and the information on the recording bit rate proportion between the video information and the audio information;
wherein the recording control unit determines the compression conditions of the compression recording control unit with reference to the recording bit rate control table based on the program information of the program.

4. A video and audio recorder according to claim 1, further comprising:
a recording scheme control table for recording the compression coding scheme for compression of the video information and the audio information, respectively;
wherein the recording control unit determines the compression conditions of the compression recording control unit with reference to the recording scheme control table based on the program information of the program.

5. A video and audio recorder according to claim 1, further comprising:
a recording scheme control table for recording as to whether the recording bit rate for compression of the video information and the audio information is variable or fixed;
wherein the recording control unit determines the compression conditions of the compression recording control unit with reference to the recording scheme control table based on the program information of the program.

6. A video and audio recorder according to claim 1, further comprising:
a compression condition recording unit for recording, for each program category acquired by the program information acquisition means, a plurality of compression conditions defining the recording bit rate for compression of the video information and the audio information and whether the recording bit rate is variable or fixed;
wherein the recording control unit determines the compression conditions of the compression recording control unit with reference to the recording scheme control table based on the program information of the program.

7. A video and audio recorder according to claim 1, further comprising:
a compression condition recording unit for recording, for each program category acquired by the program information acquisition means, a plurality of compression conditions defining the total recording bit rate for compression of the video information and the audio information and the bit rate proportion between the video information and the audio information;
wherein the recording control unit determines the compression conditions of the compression recording control unit with reference to the recording scheme control table based on the program information of the program.

8. A video and audio recorder according to claim 1, further comprising:
a recording reservation means for preparing the recording reservation information of a program based on the program information acquired by the program information acquisition means through the user operation;
wherein the conditions for compression of the video information and the audio information of the program are recorded in the recording reservation information; and
wherein the recording control unit determines the compression conditions of the compression recording control unit with reference to the recording reservation information.

9. A recording control method for a video and audio recorder for receiving a TV broadcast program and recording the contents of the program, comprising the steps of:
acquiring the program information of the program to be recorded;
determining the compression conditions of the video information and the audio information of the program based on the program information;
compressing the video information and the audio information in accordance with the compression conditions; and
multiplexing and recording the compressed video and audio information in a recording medium.

10. A recording control method according to claim 9,
wherein the compression conditions include the recording bit rate for compression of each of the video information and the audio information.

11. A recording control method according to claim 9,
wherein the compression conditions include the recording bit rate for compression of each of the video information and the audio information and the information on the bit rate proportion between the video information and the audio information.

12. A recording control method according to claim 11,
wherein in the case where the program information represents a music program, the recording bit rate is distributed equally between the video information and the audio information in accordance with the recording bit rate, and in the case where the program information represents other than a music program, the recording bit rate of the audio information is distributed as predetermined regardless of the recording bit rate.

13. A recording control method according to claim 9,
wherein the compression conditions include the compression coding scheme for compression of the video information and the audio information.

14. A recording control method according to claim 9,
wherein the compression conditions include the condition as to whether the recording bit rate for compression of the video information and the audio information is variable or fixed.

15. A recording control method according to claim 14,
wherein in the case where the program information represents selected one of a sport program, a music program, a variety show program and an animation program, the recording bit rate of the compression conditions is fixed as a high recording bit rate and variable as a low recording bit rate.

16. A recording control method according to claim 9, further comprising the steps of:
preparing the recording reservation information of a program based on the program information acquired by the program information acquisition means through the user operation;
storing the compression conditions in the recording reservation information; and
compressing the video information and the audio information in accordance with the compression conditions in the recording reservation information at the date and hour set in the recording reservation information.

17. A recording control method according to claim 9,
wherein in the case where a plurality of broadcast programs are recorded by designating the recording time, a program having the longest recording time is acquired based on the program information and the compression conditions are determined typically for the particular program.

18. A recording control method according to claim 9, further comprising the steps of:
acquiring the screen format of the program to be recorded; and
compressing the video information at a lower recording bit rate in the case where the program to be recorded is in the form of a letter box.
